(19) United States
(12) Patent Application Publication
(10) Pub. No.: US 2021/0123233 A1
(43) Pub. Date: Apr. 29, 2021

(54) CLEAN ENERGY POWER SUPPLY SYSTEM HAVING A FUNCTION OF TEMPERATURE REGULATION

(71) Applicant: CHUNG-HSIN ELECTRIC & MACHINERY MFG. CORPORATION, Taoyuan City (TW)

(72) Inventors: Ting-Kuan LI, Taoyuan City (TW); Syuan-Yi LIN, Taoyuan City (TW); Sung-Feng TSAI, Taoyuan City (TW); Wen-Chieh WANG, Taoyuan City (TW); Su-Ying LU, Taoyuan City (TW); Chia-Wen HSU, Taoyuan City (TW)

(21) Appl. No.: 16/698,854

(22) Filed: Nov. 27, 2019

(30) Foreign Application Priority Data
Oct. 29, 2019 (TW) 108138919

(51) Int. Cl. E04B 1/76; G06Q 50/06; H02J 4/00

(52) U.S. Cl. CPC E04B 1/7645; H02J 4/00; G06Q 50/06

(57) ABSTRACT

A clean energy power supply system includes a container, a thermal insulation wall, a power-generation device, a power-conversion device, and a power-distribution device. The container has an internal space and a rear door. The thermal insulation wall is located in the internal space and adjacent to the rear door. The power-generation device is disposed in an accommodating space of the container and configured to generate a clean power. The power-conversion device is disposed in the accommodating space and configured to convert the clean power into a converted power. The power-distribution device is disposed in the accommodating space and configured to output the converted power to an external load or an external power grid. The thermal insulation wall is configured to block external airflow flowing through the rear door so as to maintain the temperature of the accommodating space.

### CROSS REFERENCE TO RELATED APPLICATIONS

This application claims the benefit of TW Patent Application No. 108138919, filed Oct. 29, 2019, the entirety of which is incorporated by reference herein.

### BACKGROUND OF THE DISCLOSURE

### Field of the Disclosure

The present disclosure relates to a clean energy power supply system, and in particular it relates to a clean energy power supply system having the function of temperature regulation.

### Description of the Related Art

With the impact of global warming, the public's demand for clean energy is increasing. In today's energy development, the use of clean energy (such as wind power, solar power and hydrogen power) to replace the traditional energy generated by coal, gasoline, or diesel has become a worldwide trend.

Generally speaking, it is not suitable to place large-scale clean energy power plants in urban and suburban areas. Therefore, it is necessary to develop a small clean energy power supply system. In order to ensure a stable power supply of the clean energy power supply system, the clean energy power supply system can have energy-storage equipment that is combined with the power-generation equipment, and the clean energy power supply system can be tied to the commercial power grid or it can supply power as a standalone system. Therefore, the small clean energy power supply system has the advantages of convenient transportation and cooperatively supplying power with the commercial power grid. However, if the small clean energy power supply system is installed in a severe environment (such as a cold zone), the small clean energy power supply system may malfunction, and the lifetime of the small clean energy power supply system may be affected due to the low temperatures.

Therefore, how to design a clean energy power supply system that can operate effectively in various environments are topics nowadays that need to be discussed and solved.

### BRIEF SUMMARY OF THE DISCLOSURE

Accordingly, one objective of the present disclosure is to provide a clean energy power supply system to solve the problems described above.

According to some embodiments of the disclosure, a clean energy power supply system having a function of temperature regulation is provided and includes a container, a thermal insulation wall, a power-generation device, a power-conversion device, and a power-distribution device. The container has an internal space and a rear door. The thermal insulation wall is located in the internal space and adjacent to the rear door. The thermal insulation wall is configured to divide the internal space into an accommodating space and a separated space. The power-generation device is disposed in the accommodating space of the container and configured to generate a clean power. The power-conversion device is disposed in the accommodating space and configured to convert the clean power into a converted power. The power-distribution device is disposed in the accommodating space and configured to output the converted power to an external load or an external power grid. The thermal insulation wall is configured to block external airflow flowing through the rear door so as to maintain the temperature of the accommodating space.

According to some embodiments of the disclosure, a plurality of rotatable fins is disposed on the rear door for allowing the external airflow to flow through the rear door into the separated space when the fins are rotated and opened.

According to some embodiments of the disclosure, the rear door is made of a material whose thermal conductivity coefficient is lower than that of metal.

According to some embodiments of the disclosure, the clean energy power supply system further includes a monitor-and-control module, configured to control the fins to open when the clean energy power supply system starts up.

According to some embodiments of the disclosure, the thermal insulation wall includes a first cover corresponding to at least one fan air inlet of the power-generation device.

According to some embodiments of the disclosure, the fan air inlet faces the rear door.

According to some embodiments of the disclosure, the fan air inlet faces a base plate of the container.

According to some embodiments of the disclosure, the thermal insulation wall further includes a second cover, the clean energy power supply system further includes a plurality of shock absorbers disposed between the power-generation device and a base plate of the container, and the second cover corresponds to positions of the plurality of shock absorbers.

According to some embodiments of the disclosure, the shock absorbers include at least one of a spring, a hydraulic cylinder, a pneumatic cylinder, and an elastic pad, and the shock absorbers are fixed to the base plate.

According to some embodiments of the disclosure, the thermal insulation wall further includes a third cover corresponding to a position of the power-conversion device.

According to some embodiments of the disclosure, the power-generation device includes an exhaust port, and the thermal insulation wall further includes an opening configured to communicate with the exhaust port through a conduit.

According to some embodiments of the disclosure, the clean energy power supply system further includes a heat insulating layer disposed on inner wall surfaces of the container.

According to some embodiments of the disclosure, the clean energy power supply system further includes a temperature adjustment device configured to adjust the temperature of the accommodating space within the container.

According to some embodiments of the disclosure, the clean energy power supply system further includes a fuel storage tank disposed in the internal space, and the power-generation device is configured to draw fuel from the fuel storage tank.

According to some embodiments of the disclosure, the clean energy power supply system further includes at least one socket which is connected to the power-distribution device and is disposed on a sidewall of the container, and the at least one socket has dustproof and waterproof functions.

According to some embodiments of the disclosure, the clean energy power supply system further includes an energy storage module, configured to store the clean power from the power-generation device.

The present disclosure provides a clean energy power supply system having a function of temperature regulation. A thermal insulation wall may be disposed in the container of the clean energy power supply system to divide the internal space of the container into the accommodating space and the separated space. The thermal insulation wall can be made of a thermally insulating material (such as Polylon), and it can blocks external airflow flowing through the rear door, such that the external airflow is blocked in the separated space so as to maintain the temperature of the accommodating space. In addition, the clean energy power supply system includes the temperature adjustment device that provides a heated gas or a low temperature gas in accordance with the environment in which the clean energy power supply system is located so as to maintain the temperature of the accommodating space within a desired predetermined temperature range.

Furthermore, based on the design of the present disclosure, the maintenance personnel can disassemble one or more covers of the thermal insulation wall for repair according to the device or component needed to be repaired. That is, based on the configuration of the thermal insulation wall, not only the maintenance convenience is achieved, but also the purpose of maintaining the temperature of the accommodating space of the container can be achieved.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram of a clean energy power supply system 100 according to an embodiment of the present disclosure.

FIG. 2 is a schematic diagram of the clean energy power supply system 100 in another view according to an embodiment of the present disclosure.

FIG. 3 is a top view of the clean energy power supply system 100 after removing a top plate according to an embodiment of the present disclosure.

FIG. 4 is a front view of a partial structure of the clean energy power supply system 100 according to an embodiment of the present disclosure.

FIG. 5 is a rear view of the clean energy power supply system 100 after the rear door 1022 is opened according to an embodiment of the present disclosure.

### DETAILED DESCRIPTION OF THE ILLUSTRATIVE EMBODIMENTS

In the following detailed description, for the purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept can be embodied in various forms without being limited to those exemplary embodiments. In addition, the drawings of different embodiments can use like and/or corresponding numerals to denote like and/or corresponding elements in order to clearly describe the present disclosure. However, the use of like and/or corresponding numerals in the drawings of different embodiments does not suggest any correlation between different embodiments. The directional terms, such as “up”, “down”, “left”, “right”, “front” or “rear”, are reference directions for accompanying drawings. Therefore, using the directional terms is for description instead of limiting the disclosure.

The terms “first”, “second”, “third”, “fourth”, and the like are merely generic identifiers and, as such, may be interchanged in various embodiments. For example, while an element may be referred to as a “first” element in some embodiments, the element may be referred to as a “second” element in other embodiments.

In this specification, relative expressions are used. For example, “lower”, “bottom”, “higher” or “top” are used to describe the position of one element relative to another. It should be appreciated that if a device is flipped upside down, an element at a “lower” side will become an element at a “higher” side.

The terms “about” and “substantially” typically mean +/−20% of the stated value, more typically +/−10% of the stated value and even more typically +/−5% of the stated value. The stated value of the present disclosure is an approximate value. When there is no specific description, the stated value includes the meaning of “about” or “substantially”.

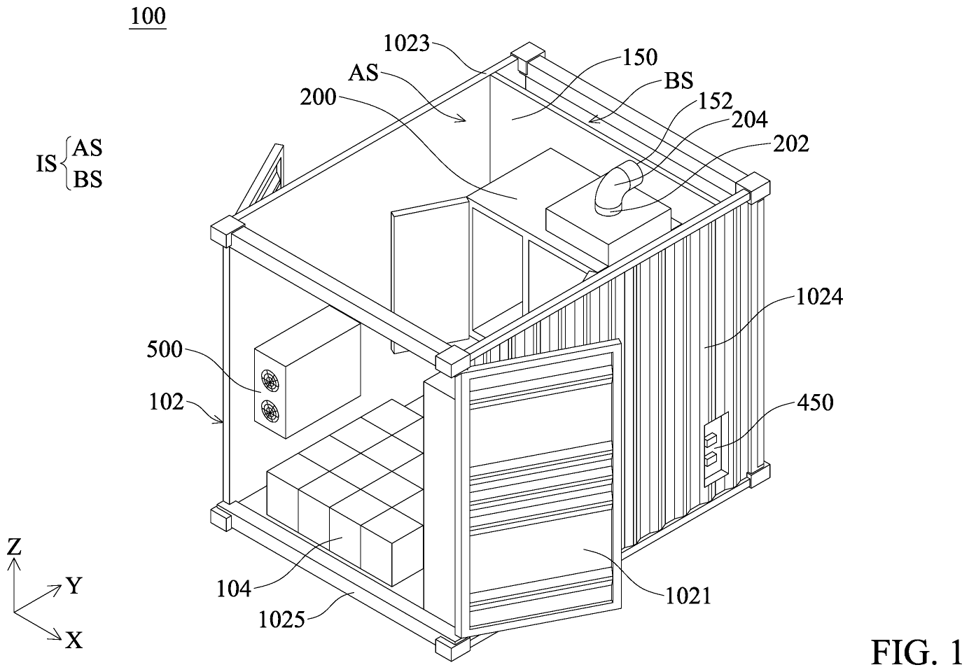

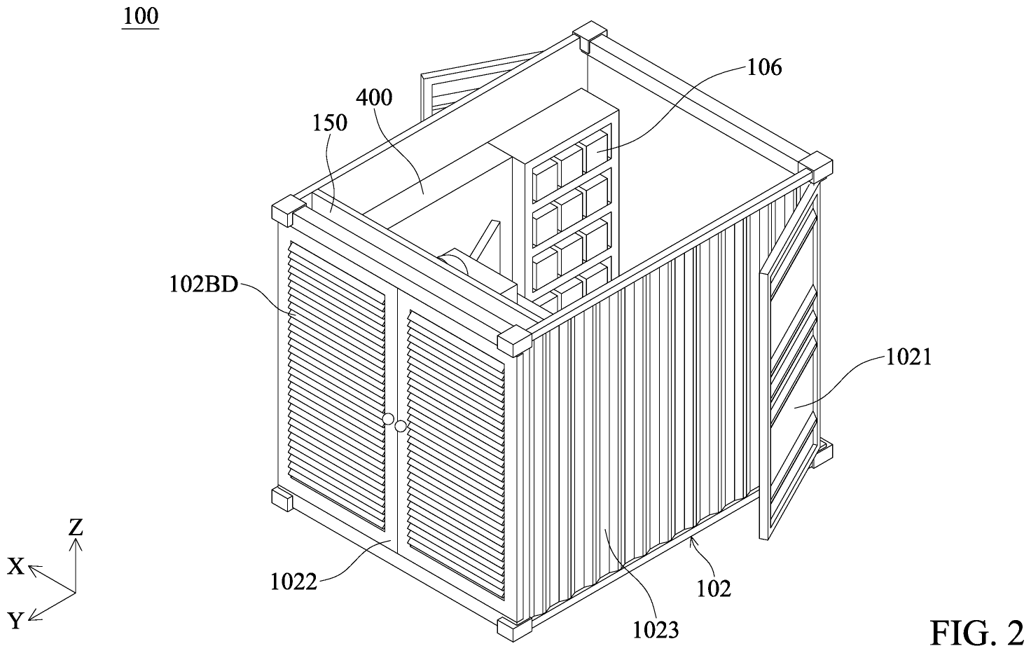

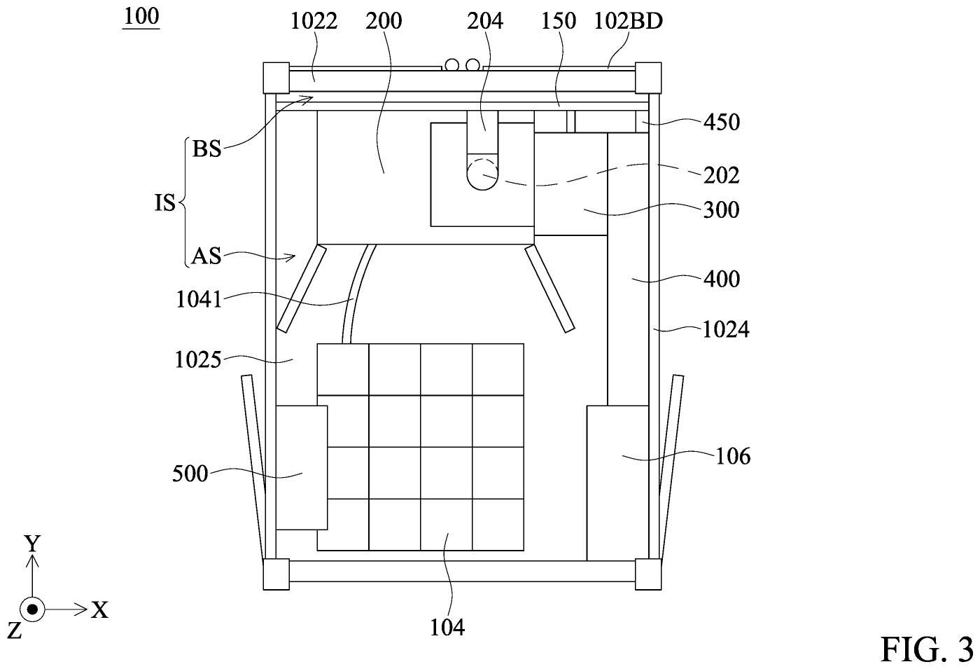

Please refer to FIG. 1 to FIG. 3. FIG. 1 is a schematic diagram of a clean energy power supply system 100 according to an embodiment of the present disclosure, FIG. 2 is a schematic diagram of the clean energy power supply system 100 in another view according to an embodiment of the present disclosure, and FIG. 3 is a top view of the clean energy power supply system 100 after removing a top plate according to an embodiment of the present disclosure. In this embodiment, the clean energy power supply system 100 includes a housing 102. The housing 102 can be a container and has a top plate (the top plate is omitted for clarity), two front doors 1021, a rear door 1022, and two side walls 1023, 1024 and a base plate 1025, and the container 102 can form an internal space IS.

As shown in the figures, the clean energy power supply system 100 further includes a power-generation device 200, a power-conversion device 300, and a power-distribution device 400. The power-generation device 200 is disposed in the internal space IS of the container 102. The power-generation device 200 can be a methanol fuel cell power-generation device configured to generate a clean power, but it is not limited thereto. The power-conversion device 300 is disposed in the internal space IS and is configured to convert the clean power into a converted power. Then, the power-distribution device 400 is also disposed in the internal space IS and is configured to output the converted power to an external load or a power grid.

As shown in FIG. 1, the clean energy power supply system 100 may further include at least one socket 450 which is connected to the power-distribution device 400 and is disposed on the sidewall 1024 of the container 102. The socket 450 can be connected to an external plug, and the external plug is connected to the aforementioned external load or the power grid. It should be noted that because the socket 450 and the aforementioned external plug are exposed to the external environment of the container 102, they can be designed to be with dustproof and waterproof functions to stop environmental factors from causing damage to the socket 450 or the aforementioned external plug, and to prevent dust or water from entering the container 102 through the socket 450. For example, the socket 450 and the external plug are made of a waterproof material, and a cover can be disposed on the socket 450. When the socket 450 is not connected to the external plug, the cover can cover the socket 450, so as to isolate the internal space of the socket 450 having electrical conductors from the external environment. The cover and the body of the socket 450 are completely tight to prevent dust or water from penetrating into the internal space of the socket 450 having electrical conductors. When the socket 450 is connected to the external plug, the cover is opened, and the external plug and the body of the socket 450 are completely sealed to prevent dust or water from penetrating into the internal space of the socket 450 having electrical conductors.

As shown in FIG. 1 and FIG. 3, the clean energy power supply system 100 may further include a fuel storage tank 104 disposed in the internal space IS, and the power-generation device 200 may draw fuel from the fuel storage tank 104 through a connection pipe 1041 for the manufacturing process of the clean power. It should be noted that, in other embodiments, the fuel storage tank 104 can also be integrated within the power-generation device 200. Furthermore, the clean energy power supply system 100 can further include an energy storage module 106, for example having a plurality of batteries, configured to store the aforementioned clean power from the power-generation device 200.

As shown in FIG. 2, the rear door 1022 may be a louver door, and a plurality of rotatable fins 102BD is disposed on the rear door 1022. When the fins 102BD are rotated and opened, the airflow outside the container 102 may flow through the rear door 1022 into the separated space BS. Furthermore, as shown in FIG. 1 to FIG. 3, the clean energy power supply system 100 may further include a thermal insulation wall 150 disposed in the container 102 and adjacent to the rear door 1022, and the thermal insulation wall 150 may separate the internal space IS into an accommodating space AS and the separated space BS.

In an embodiment, the distance between the thermal insulation wall 150 and the rear door 1022 along the Y-axis may be 5 to 100 cm, but it is not limited thereto. For example, this distance can be 31 cm.

The thermal insulation wall 150 may be made of a thermal insulation material (such as Polylon) configured to block the external airflow flowing through the rear door 1022, such that the external airflow is blocked in the separated space BS, thereby maintaining the temperature of the accommodating space AS of the internal space IS.

Furthermore, the clean energy power supply system 100 can further include a temperature adjustment device 500 configured to adjust the temperature of the accommodating space AS within the container 102. The temperature adjustment device 500 can be a cold air conditioner, a heater or an air conditioner, but it is not limited thereto. For example, when the clean energy power supply system 100 is disposed in the cold zone, the temperature adjustment device 500 can provide a heated gas to circulate in the accommodating space AS to maintain the temperature of the accommodating space AS within a predetermined temperature range, for example, 20 to 25 degrees Celsius.

In an embodiment, when the temperature of the accommodating space AS is lower than 20 degrees Celsius, the temperature adjustment device 500 is activated to provide a heated gas to increase the temperature of the accommodating space AS. Then, when the temperature of the accommodating space AS rises above 25 degrees Celsius, the temperature adjustment device 500 stops providing the heated gas.

Similarly, when the clean energy power supply system 100 is disposed in a tropical zone, the temperature adjustment device 500 can provide a low temperature gas to circulate within the accommodating space AS to maintain the temperature of the accommodating space AS within a predetermined temperature range, such as 25 to 30 degrees Celsius. For example, when the temperature of the accommodating space AS is higher than 30 degrees Celsius, the temperature adjustment device 500 is activated to provide a low temperature gas, thereby reducing the temperature of the accommodating space AS. Then, when the temperature of the accommodating space AS drops below 25 degrees Celsius, the temperature adjustment device 500 stops providing the low temperature gas.

In this embodiment, the top wall, the side walls 1023, 1024, and the base plate 1025 of the container 102 may be made of a metal material, but they are not limited thereto. In addition, the rear door 1022 may be made of a material whose thermal conductivity coefficient is lower than that of metal. For example, the rear door 1022 may be made of wood, so that the heat conduction between the side walls 1023, 1024 and the rear door 1022 can be reduced.

In addition, in order to further improve the efficiency of maintaining the temperature in the accommodating space AS, the clean energy power supply system 100 may further include a heat insulating layer (not shown in the figures) disposed on the inner wall surfaces of the container 102. For example, the heat insulating layer can be disposed on the inner wall surfaces of the top plate, the base plate 1025, the front door 1021, and the side walls 1023, 1024.

In an embodiment of the present disclosure, the clean energy power supply system 100 may further include a monitor-and-control module configured to control the operation of the power-generation device 200, the power-conversion device 300, the power-distribution device 400, and the energy storage module 106. In addition, the foregoing monitor-and-control module can also control the opening or closing of the fins 102BD of the rear door 1022. For example, when the clean energy power supply system 100 starts up, the monitor-and-control module controls the fins 102BD to open, or when the clean energy power supply system 100 is on standby, the monitor-and-control module controls the fins 102BD to close. In this embodiment, the foregoing monitor-and-control module can be integrated in the power-distribution device 400, but it is not limited thereto.

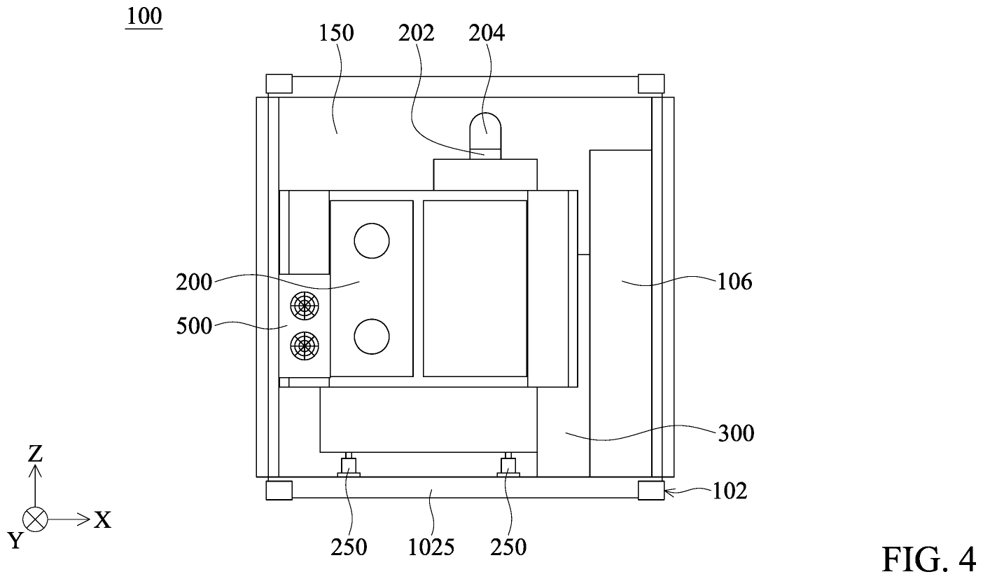

Next, please refer to FIG. 4, which is a front view of a partial structure of the clean energy power supply system 100 according to an embodiment of the present disclosure (for clarity, the fuel storage tank 104 is omitted in this figure). In this embodiment, the clean energy power supply system 100 may further include a plurality of shock absorbers 250 disposed between the power-generation device 200 and the base plate 1025 of the container 102. The shock absorbers 250 can be at least one of a spring, a hydraulic cylinder, a pneumatic cylinder, and an elastic pad, and the shock absorbers 250 are fixed to the base plate 1025.

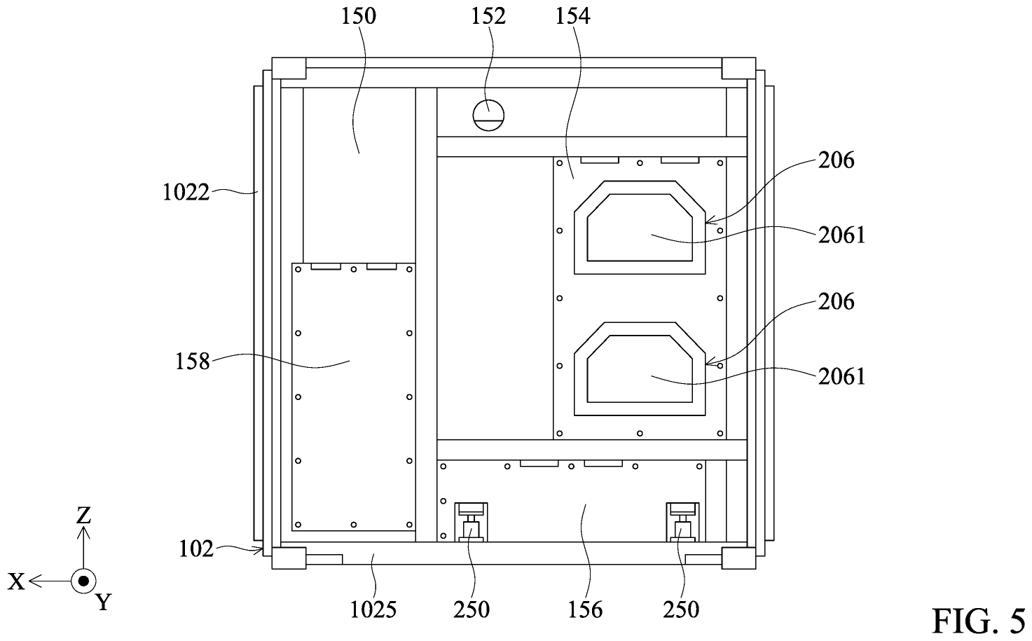

Next, please refer to FIG. 1, FIG. 3 and FIG. 5. FIG. 5 is a rear view of the clean energy power supply system 100 after the rear door 1022 is opened according to an embodiment of the present disclosure. As shown in the figures, the power-generation device 200 is in contact with the thermal insulation wall 150 and may include an exhaust port 202, and the thermal insulation wall 150 further includes an opening 152 configured to communicate with the exhaust port 202 through a conduit 204. Thus, the exhaust gas and water vapor generated by the power-generation device 200 can be discharged to the outside of the container 102 via the opening 152 and the rear door 1022.

As shown in FIG. 5, the thermal insulation wall 150 may include a first cover 154 corresponding to two fan intake pipes 206 of the power-generation device 200. In this embodiment, fan air inlets 2061 of the fan intake pipes 206 face the rear door 1022 such that external airflow can enter the power-generation device 200 through the rear door 1022 and the fan air inlets 2061.

When the power-generation device 200 needs to be repaired, the maintenance personnel can open the rear door 1022 to go into the separated space BS, and then disassemble the first cover 154 to expose a part of the power-generation device 200. After that, the maintenance personnel can repair the power-generation device 200.

It should be noted that, in other embodiments, the fan air inlets 2061 can be designed to face the base plate 1025 of the container 102 so as to prevent foreign objects (such as snow) from entering the power-generation device 200 through the fan air inlets 2061 when the maintenance personnel open the rear door 1022.

In addition, the thermal insulation wall 150 may also include a second cover 156 corresponding to the positions of the plurality of shock absorbers 250. When the shock absorbers 250 need to be repaired or the power-generation device 200 needs to be moved, the maintenance personnel can disassemble the second cover 156 and then repair the shock absorbers 250, or the maintenance personnel can disconnect the shock absorbers 250 from the power-generation device 200 so that the power-generation device 200 can be moved.

Furthermore, the thermal insulation wall 150 may further include a third cover 158 corresponding to the position of the power-conversion device 300. When the power-conversion device 300 needs to be repaired, the maintenance personnel can disassemble the third cover 158 and then repair the power-conversion device 300.

The present disclosure provides a clean energy power supply system 100 having the function of temperature regulation. A thermal insulation wall 150 may be disposed in the container 102 of the clean energy power supply system 100 to divide the internal space IS of the container 102 into the accommodating space AS and the separated space BS. The thermal insulation wall 150 can be made of a thermally insulating material (such as Polylon), and it can blocks external airflow flowing through the rear door 1022, such that the external airflow is blocked in the separated space BS so as to maintain the temperature of the accommodating space AS. In addition, the clean energy power supply system 100 includes the temperature adjustment device 500 that provides a heated gas or a low temperature gas in accordance with the environment in which the clean energy power supply system 100 is located so as to maintain the temperature of the accommodating space AS within a desired predetermined temperature range.

Furthermore, based on the design of the present disclosure, the maintenance personnel can disassemble one or more covers of the thermal insulation wall 150 for repair according to the device or component needed to be repaired. That is, based on the configuration of the thermal insulation wall 150, not only the maintenance convenience is achieved, but also the purpose of maintaining the temperature of the accommodating space AS of the container 102 can be achieved.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, composition of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, composition of matter, means, methods, or steps. In addition, each claim constitutes a separate embodiment, and the combination of various claims and embodiments are within the scope of the disclosure.

What is claimed is:

1. A clean energy power supply system, comprising:
a container, having an internal space and a rear door;
a thermal insulation wall, located in the internal space and adjacent to the rear door, wherein the thermal insulation wall is configured to divide the internal space into an accommodating space and a separated space;
a power-generation device, disposed in the accommodating space of the container and configured to generate a clean power;
a power-conversion device, disposed in the accommodating space and configured to convert the clean power into a converted power; and
a power-distribution device, disposed in the accommodating space and configured to output the converted power to an external load or an external power grid
wherein the thermal insulation wall is configured to block external airflow flowing through the rear door so as to maintain the temperature of the accommodating space.

2. The clean energy power supply system as claimed in claim 1, wherein a plurality of rotatable fins is disposed on the rear door for allowing the external airflow to flow through the rear door into the separated space when the fins are rotated and opened.

3. The clean energy power supply system as claimed in claim 2, wherein the rear door is made of a material whose thermal conductivity coefficient is lower than that of metal.

4. The clean energy power supply system as claimed in claim 2, wherein the clean energy power supply system further comprises a monitor-and-control module, configured to control the fins to open when the clean energy power supply system starts up.

5. The clean energy power supply system as claimed in claim 1, wherein the thermal insulation wall includes a first cover corresponding to at least one fan air inlet of the power-generation device.

6. The clean energy power supply system as claimed in claim 5, wherein the fan air inlet faces the rear door.

7. The clean energy power supply system as claimed in claim 5, wherein the fan air inlet faces a base plate of the container.

8. The clean energy power supply system as claimed in claim 5, wherein the thermal insulation wall further includes a second cover, the clean energy power supply system further comprises a plurality of shock absorbers disposed between the power-generation device and a base plate of the container, and the second cover corresponds to positions of the plurality of shock absorbers.

9. The clean energy power supply system as claimed in claim 8, wherein the shock absorbers include at least one of a spring, a hydraulic cylinder, a pneumatic cylinder, and an elastic pad, and the shock absorbers are fixed to the base plate.

10. The clean energy power supply system as claimed in claim 8, wherein the thermal insulation wall further includes a third cover corresponding to a position of the power-conversion device.

11. The clean energy power supply system as claimed in claim 10, wherein the power-generation device includes an exhaust port, and the thermal insulation wall further includes an opening configured to communicate with the exhaust port through a conduit.

12. The clean energy power supply system as claimed in claim 1, wherein the clean energy power supply system further comprises a heat insulating layer disposed on inner wall surfaces of the container.

13. The clean energy power supply system as claimed in claim 1, wherein the clean energy power supply system further comprises a temperature adjustment device configured to adjust the temperature of the accommodating space within the container.

14. The clean energy power supply system as claimed in claim 1, wherein the clean energy power supply system further comprises a fuel storage tank disposed in the internal space, and the power-generation device is configured to draw fuel from the fuel storage tank.

15. The clean energy power supply system as claimed in claim 1, wherein the clean energy power supply system further comprises at least one socket which is connected to the power-distribution device and is disposed on a sidewall of the container, and the at least one socket has dustproof and waterproof functions.

16. The clean energy power supply system as claimed in claim 1, wherein the clean energy power supply system further comprises an energy storage module, configured to store the clean power from the power-generation device.
